(19) United States
(12) Patent Application Publication
(10) Pub. No.: US 2013/0240005 A1
(43) Pub. Date: Sep. 19, 2013

(54) CLEANING SYSTEM FOR SOLAR PANEL

(71) Applicants: TEN-CHEN HO, Tu-Cheng (TW); XIAO-LIAN HE, Shenzhen City (CN)

(72) Inventors: TEN-CHEN HO, Tu-Cheng (TW); XIAO-LIAN HE, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/561,344

(22) Filed: Jul. 30, 2012

(30) Foreign Application Priority Data
Mar. 13, 2012 (CN) 201210063920.9

(51) Int. Cl. B08B 7/00

(52) U.S. Cl. 134/56 R

(57) ABSTRACT

A cleaning system for solar panels includes first and second cleaning units, first and second control units, first and second power measuring units to measure a first power outputted from a first solar panel per interval of time and a second power outputted from a second solar panel per interval of time, and a processing unit. The processing unit reads the first and second powers and the first and second coefficients, and determines whether the second power is less than a product of the first power, the first coefficient, and the second coefficient. When the second power is less than the product, the processing unit outputs a control signal to the second control unit. The second control unit controls the second clean unit to clean the second solar panel.

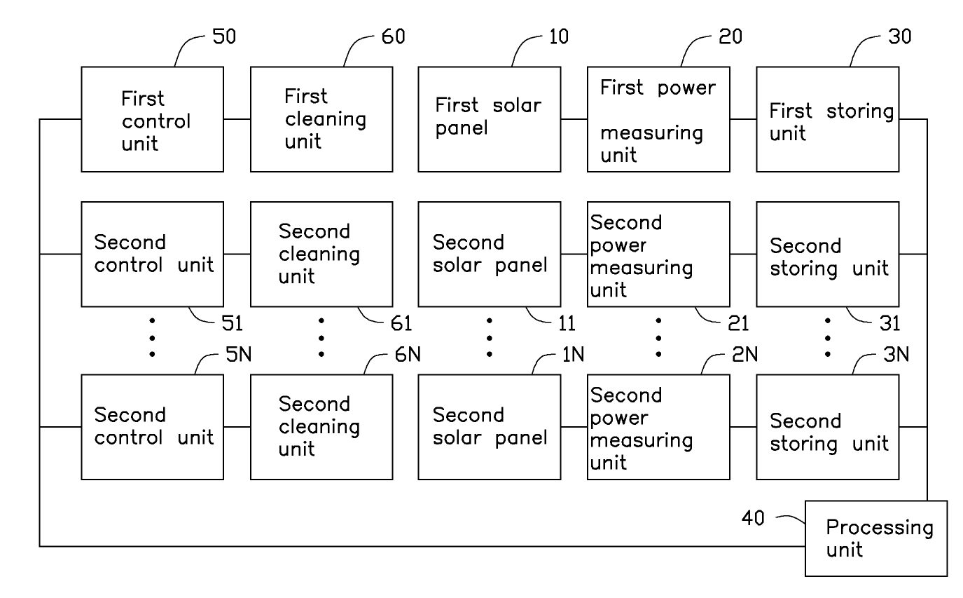

### BACKGROUND

1. Technical Field

The present disclosure relates to a system for cleaning a solar panel.

2. Description of Related Art

Solar energy is an excellent alternative source of energy, and has found widespread applications in a variety of fields. However, when a solar panel has been used for a period of time, the solar panel may be become dirty, such that the efficiency of the solar panel would be reduced. However, the cleaning of the solar panels are mostly done manually. This is inconvenient.

### BRIEF DESCRIPTION OF THE DRAWING

Many aspects of the embodiments can be better understood with reference to the following drawing. The components in the drawing are not necessarily drawn to scale, the emphasis instead being placed upon clearly illustrating the principles of the present embodiments. Moreover, in the drawing, like reference numerals designate corresponding parts throughout the several views.

The FIGURE is a block diagram of an exemplary embodiment of a cleaning system for solar panels.

### DETAILED DESCRIPTION

The disclosure, including the accompanying drawing, is illustrated by way of examples and not by way of limitation. It should be noted that references to “an” or “one” embodiment in this disclosure are not necessarily to the same embodiment, and such references mean at least one.

Referring to the FIGURE, an exemplary embodiment of a cleaning system for solar panels is shown. The solar panels include a first solar panel 10 and N second solar panels 11-1N. The first solar panel 10 is a reference solar panel. The second solar panels 11-1N are solar panels to be cleaned. The first solar panel 10 and the N second solar panels 11-1N collect solar energy and convert the solar energy to electrical energy. In the embodiment, N is an integer not less than one.

The cleaning system includes a first power measuring unit 20, N second power measuring units 21-2N, a first storing unit 30, N second storing units 31-3N, a processing unit 40, a first control unit 50, N second control units 51-5N, a first cleaning unit 60, and N second cleaning units 61-6N.

In the embodiment, the first control unit 50 controls the first cleaning unit 60 to clean the first solar panel 10 per interval of time (such as twelve hours). As a result, the first solar panel 10 is almost clean all the time. The first power measuring unit 20 measures a power P0 outputted from the first solar panel 10 per unit interval. The first storing unit 30 stores the power P0 measured by the first power measuring unit 20.

The second power measuring units 21-2N measure powers P1n outputted from the second solar panels 11-1N correspondingly per interval of time, where n is a natural number which is less than (N+1). For example, the second power measuring unit 21 measures a power P11 outputted from the second solar panel 11 per interval of time, and the second power measuring unit 26 measures a power P16 output from the second solar panel 16 per interval of time. The second storing units 31-3N store the power P1n measured by the second power measuring unit 21-2N correspondingly. Each second storing unit further stores a proportional coefficient Kn between the power outputted from each second solar panel when the second solar panel is clean and the power outputted from the first solar panel 10 per interval of time. In other words, Kn=P2n/P0, where P2n stands for the power outputted from a second solar panel per interval of time when the second solar panel is clean. For example, P21 stands for the power outputted from the second solar panel 11 when the second solar panel 11 is clean. Moreover, each second storing unit further stores a preset coefficient M (such as 90%). When the power outputted from a second solar panel is less than M times of the power P2n, the second solar panel needs to be cleaned.

The processing unit 40 reads the power P0 measured by the first power measuring unit 20 per interval of time, the power P1n measured by the second power measuring units 21-2N per interval of time, the proportional coefficient Kn, and the preset coefficient M. The processing unit 40 further compares the power P1n with a product of the power P0, the proportional coefficient Kn, and the preset coefficient M. In other words, the processing unit 40 determines whether the following formula is satisfied: P1n<P0×Kn×M. If P1n<P0×Kn×M, the corresponding second solar panel is to be cleaned. The processing unit 40 outputs a control signal to the corresponding second control unit. The second control unit controls the corresponding second cleaning unit to clean the second solar panel. For example, when P15<P0×K5×M, the second solar panel 15 is need to be cleaned. The processing unit 40 outputs a control signal to the second control unit 55. The second control unit 55 controls the second cleaning unit 65 to clean the second solar panel 15.

In the embodiment, the preset coefficient M is depended on weather. For example, when it is a sunny day, the preset coefficient M can be set as 90%. When it is a cloudy day, the preset coefficient M can be set as 80%. Operators can set the preset coefficient M according to need.

The foregoing description of the exemplary embodiments of the disclosure has been presented only for the purposes of illustration and description and is not intended to be exhaustive or to limit the disclosure to the precise forms disclosed. Many modifications and variations are possible in the light of everything above. The embodiments were chosen and described in order to explain the principles of the disclosure and their practical application so as to enable others of ordinary skill in the art to utilize the disclosure and various embodiments with various modifications as are suited to the particular use contemplated. Alternative embodiments will become apparent to those of ordinary skills in the art to which the present disclosure pertains without departing from its spirit and scope. Accordingly, the scope of the present disclosure is defined by the appended claims rather than the foregoing description and the exemplary embodiments described therein.

What is claimed is:

1. A cleaning system for solar panels, the solar panels comprising a first solar panel and a second solar panel, the cleaning system comprising:
a first cleaning unit;
a first control unit operable to control the first cleaning unit to clean the first solar panel per interval of time;
a first power measuring unit operable of measuring a first power outputted from the first solar panel per interval of time;
a first storing unit operable of storing the first power;
a second power measuring unit operable of measuring a second power outputted from the second solar panel per interval of time;
a second storing unit operable of storing the second power, a first coefficient and a second coefficient;
a second cleaning unit; and
a processing unit operable of reading the first power, the second power, the first coefficient, and the second coefficient, and determining whether the second power is less than a product of the first power, the first coefficient and the second coefficient; wherein when the second power is less than the product of the first power, the first coefficient and the second coefficient, the processing unit outputs a control signal to the second control unit, the second control unit controls the second cleaning unit to clean the second solar panel.

2. The cleaning system of claim 1, wherein the first coefficient is a proportion between a power outputted from a second solar panel when the second solar panel is clean and the first power outputted from the first solar panel.

3. A cleaning system for solar panels, the solar panels comprising a first solar panel and a plurality of second solar panels, the cleaning system comprising:
a first cleaning unit;
a first control unit operable to control the first cleaning unit to clean the first solar panel per interval of time;
a first power measuring unit operable to measure a first power outputted from the first solar panel per interval of time;
a first storing unit operable to store the first power;
a plurality of second power measuring units, the second power measuring units having a same number with the second solar panels, wherein each second power measuring unit is operable of measuring a second power outputted from a corresponding second solar panel per interval of time;
a plurality of second storing units, the second storing units having a same number with the second solar panels, wherein each second storing unit stores a second power outputted from a corresponding second solar panel, a first coefficient and a second coefficient;
a plurality of second cleaning units, the second cleaning units having a same number with the second solar panels; and
a processing unit operable of reading the first power, the second power, the first coefficients, and the second coefficients, and determining whether the second power outputted from a second solar panel is less than a product of the first power, the first coefficient corresponding to the second solar panel, and the second coefficient corresponding to the second solar panel; when the second power outputted from the second solar panel is less than the product of the first second power, the first coefficient corresponding to the second solar panel, the processing unit outputs a control signal to a second control unit corresponding to the second solar panel, the second control unit controls the corresponding second cleaning unit to clean the second solar panel.

4. The cleaning system of claim 3, wherein the first coefficient is a proportion between a power output from a second solar panel when the second solar panel is clean and a power output from the first solar.
